(19) United States
(12) Patent Application Publication
(10) Pub. No.: US 2002/0122073 A1
(43) Pub. Date: Sep. 5, 2002

(54) Visual navigation history

(76) Inventors: David Hardin Abrams, Chicago, IL (US); James Bullard, Evanston, IL (US); Peter N. Prokopowicz, Oak Park, IL (US)

Correspondence Address: MARK J. SPOLYAR, 175 PERALTA AVE., SAN FRANCISCO, CA, 94110, US

(21) Appl. No.: 09/798,768

(22) Filed: Mar. 2, 2001

(51) Int. Cl. G06F 3/00; G06F 13/00

(52) U.S. Cl. 345/838

(57) ABSTRACT

Methods, apparatuses and systems facilitating the creation, management and implementation of image histories associated with use of telepresence systems. The present invention extends and enhances the capabilities of current telepresence systems for both users and systems administrators.

### FIELD OF THE INVENTION

The present invention relates to camera and image acquisition systems connected to computer networks and, more particularly, relates to systems, apparatuses, and methods allowing for a visual history of a user's session navigating through a remote location via computer-controlled camera or image acquisition systems.

### BACKGROUND OF THE INVENTION

One of the least anticipated and most powerful aspects of the Internet is the degree to which it has become a medium for visual communication. Although the Internet originated as a way to share data and text, networking and display technology breakthroughs have resulted in an on-line world where you do not just read information but take it in via multi-sensory perception (such as by viewing images and hearing sounds). This has created demand for communication that satisfies the innate human desire to look at something and accounts for the increasing popularity of “webcams,” that is, cameras connected to the Internet (or other Wide Area Network or “WAN”), accessible to users, that communicate still or video images of a physical location.

Cameras such as these, or other image acquisition devices, operably connected to the Internet allow users to view live images of various physical locations, such as amusement parks, beaches, parks, retail stores, and sports stadiums. The use of such webcams ranges, for example, from a single camera connected to a lone computer providing a view of a dorm room to an array of image acquisition devices networked with multiple computers (or industrial appliances) showing various views of an airfield. In addition, by extending this technology, current “telepresence” systems offer users the ability to navigate through remote physical locations by remotely controlling a camera or image acquisition system.

By these means, a network user with nothing more than a browser can connect to views from anywhere in the world by simply clicking on Uniform Resource Locators (URLs) that contain links to remote webcams available over the Internet. Furthermore, the use of computer-controlled cameras, as described above, allows the user to navigate a remote physical location by requesting images of selected regions in the physical location. In light of their widespread use and applicability to a wide range of applications, a need in the art of telepresence systems exist for methods and system that enhance and/or facilitate the user's session navigating a remote physical location. For example, during such sessions the user often desires to revisit an area he or she has already viewed for further inspection. The functionality of standard browsers (in connection with the prior art servers that interact with them) include general purpose functionality associated with browsing, allowing for 1) maintenance at a client computer a primitive browsing history (accessible with the “Back” button), 2) bookmarking of Uniform Resource Locators (URLs), and 3) client-side caching of requested data and files. However, such prior art systems are not specifically adapted to visual navigation of remote locations and do not allow administrator's efficient access to users' visual navigation sessions. For example, prior art systems require the user to repeatedly click the browser's “Back” button until the desired view is once again displayed. One embodiment of the present invention addresses this situation and enhances access to images captured during the user's session. For example, one embodiment of the present invention displays a visual representation of the user's navigation history (e.g., in a series of thumbnails including embedded links to corresponding live images). In addition, one embodiment of the present invention allows a user to bookmark certain views and return to them with a single click. Moreover, the methods, apparatuses and systems in some embodiments of the present invention allow a site administrator to monitor in real-time the respective navigation histories of users currently using the site. Embodiments of the present invention also facilitate a chat-based discussion of the user's visual navigation session.

### SUMMARY OF THE INVENTION

The present invention provides methods, apparatuses and systems facilitating the creation, management and implementation of image histories associated with the use of telepresence systems. The present invention extends and enhances the capabilities of current telepresence systems for both users and systems administrators. Embodiments of the present invention enhance a user's ability to navigate a remote physical location by providing a visual representation of the user's session. One embodiment allows users to create visual bookmarks of a session. Other embodiments of the present invention facilitate monitoring and analysis of use of one or more telepresence systems.

### DESCRIPTION OF THE DRAWINGS

FIG. 1 is a functional block diagram illustrating one embodiment of the present invention.

FIG. 2 is a functional block diagram setting forth a second embodiment of the present invention.

FIG. 3 is a functional block diagram showing a third embodiment of the present invention.

FIG. 4 is a flow chart setting forth a method pursuant to one embodiment of the present invention.

FIG. 5 illustrates a user interface according to an embodiment of the present invention.

FIG. 6 is a flow chart diagram illustrating a method according to one embodiment of the present invention.

FIG. 7 is a perspective view of a remote physical location according to one embodiment of the present invention.

FIG. 8 illustrates a user interface according to a second embodiment of the present invention.

### DESCRIPTION OF PREFERRED EMBODIMENT(S)

### I. Operating Environment

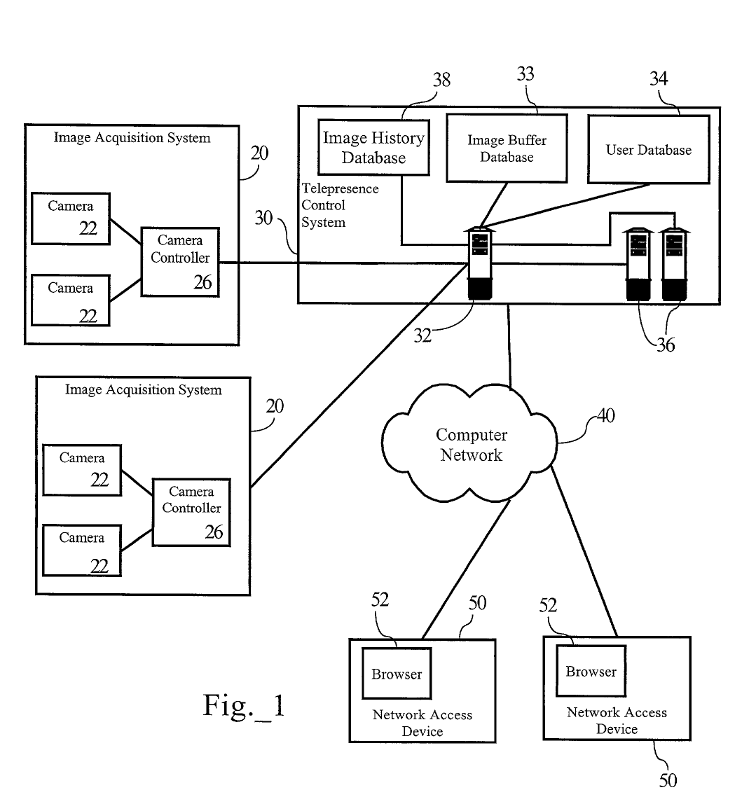

FIG. 1 shows an embodiment of the present invention as applied to a Wide Area Network, such as the Internet. One embodiment of the present invention involves at least one network access device 50 associated with one or more users, at least one camera 22, and at least one telepresence control system 30, all of which are communicably connected to a computer network (such as the Internet). The embodiment of FIG. 1 further includes image acquisition system 20 including cameras 22 located remotely from network access device 50 and communicably connected to telepresence control system 30. The present invention can be applied across any computer network, such as a Local Area Network, a Wide Area Network, and/or any combination thereof. Suitable types of computer networks include, but are not limited to, a wireless computer network, an electronic network, an optical network, and any combination thereof.

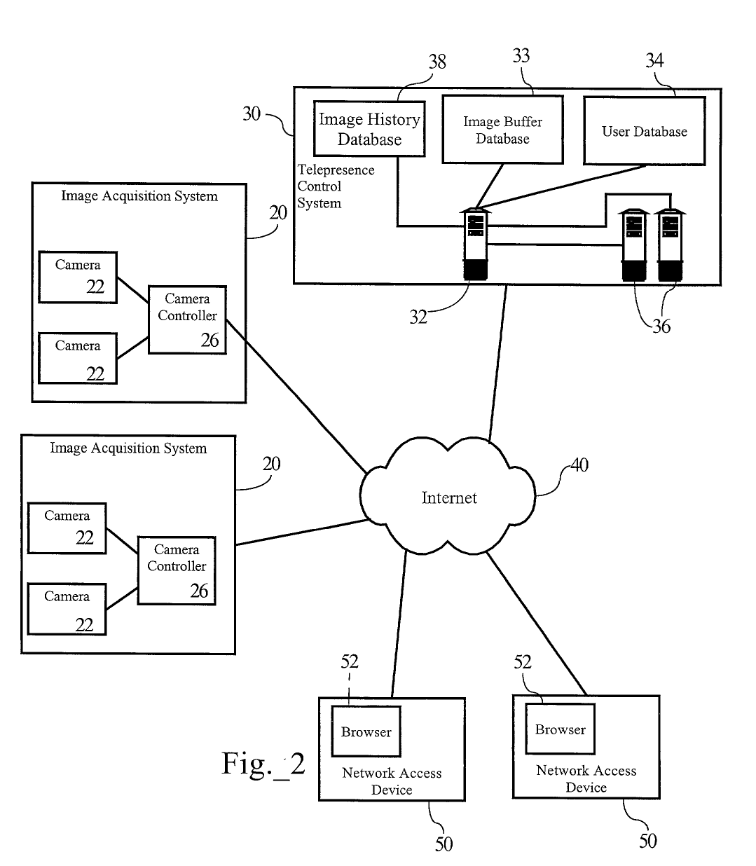

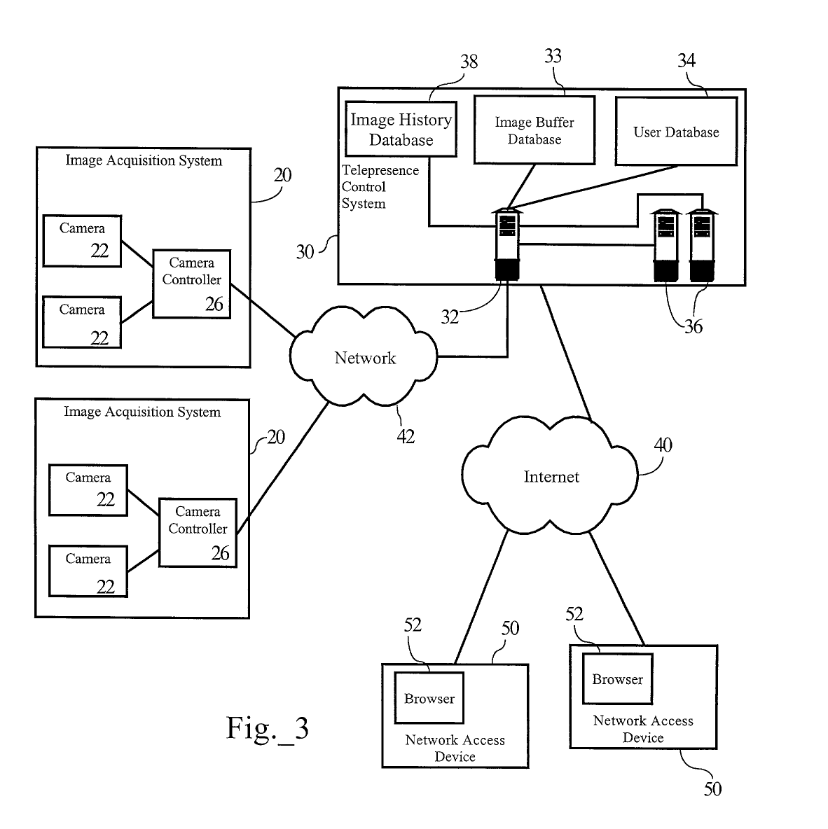

As FIGS. 2 and 3 demonstrate, the present invention can be implemented in a variety of network configurations. FIG. 2, for example, shows image acquisitions systems 20 operably connected to telepresence control system 30 via computer network 40. FIG. 3 illustrates a system where image acquisition systems 20 are communicably connected to telepresence control system 30 via computer network 42 (such as a Local Area Network (LAN) or a second Wide Area Network (WAN)). Network access devices 50, however, are communicably connected to telepresence control system 30 via another computer network 40 (such as a second LAN or the Internet). In addition, communication between network access device 50 and telepresence control system 30 can occur via a dedicated line.

A. Telepresence Control System

Telepresence control system 30 receives requests for images of selected regions of a remote physical location from users at network access devices 50 and transmits images in return. In one embodiment, telepresence control system 30 is operably connected to at least one image acquisition system 20 to request and receive images from image acquisition system 20 in response to requests from users. In one form, telepresence control system 30 receives image data from image acquisition system 20 and transmits the image data to users in response to their requests.

Telepresence control system 30, in one embodiment, includes web servers 36, which receive requests submitted by users and transmit files and other documents in return.

According to one embodiment of the present invention, telepresence control system 30 further includes image server 32, image buffer database 33, user database 34, and image history database 38. As FIG. 1 shows, image server 32 is operably connected to image acquisition system 20. Image server 32, in one embodiment, receives requests for images of regions in a remote physical location, transmits control signals to image acquisition system 20, receives images from image acquisition system 20 and transmits image data to users via web servers 36. Image buffer database 33 stores images of selected regions in a remote physical location captured by image acquisition systems 20. User database 34 stores data relating to users of the system. Image history database 38 stores archived images requested by users during past sessions. One skilled in the art will recognize from the description provided below that the division of functionality between servers 32 and 36 is not required by any constraint and that all the functions performed by servers 32 and 36 may be allocated to one server or distributed among a plurality of servers.

Image buffer database 33, user database 34, and image history database 38 can be any form of database known in the art (for example, a relational database or flat-file database). In one embodiment, each database has associated therewith a collection of computer programs enabling the storage, modification, and extraction of information in the database. The databases may be stored on any suitable device ranging from personal computers (for small systems) to mainframes (for large systems). In addition, the functionality of servers 32 and 36 may be implemented in hardware or software, or a combination of both. In one embodiment, each server is a programmable computer executing computer programs, comprising at least one processor, a data storage system, at least one input device, and at least one output device. In addition, as one skilled in the art will recognize, the databases described above may reside on image server 32 or web server 36, or may be physically separate, but operably connected thereto.

B . Image Acquisition System

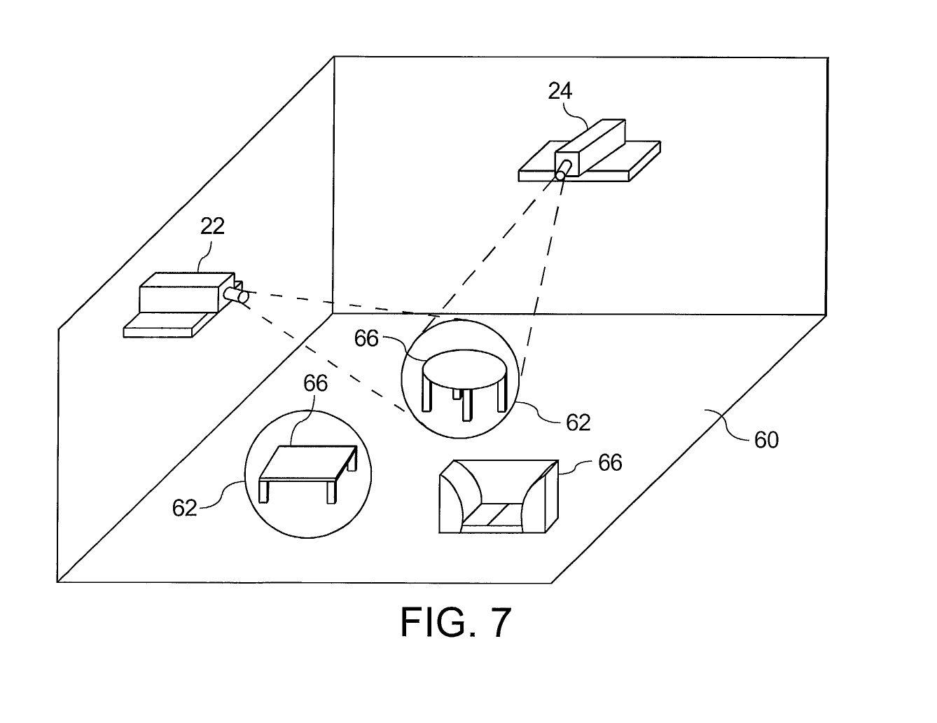

Image acquisition system 20 captures images of a remote physical location and transmits image data to image server 32. As FIGS. 1 and 7 illustrate, in one embodiment, image acquisition system 20 comprises cameras 22 operably coupled to and controlled by camera controller 26. Cameras 22 capture images of selected regions 62 in remote physical location 60. Of course, any number and combination of cameras and device controllers may be used. In another embodiment, the image capture, control and compression functionality of camera controller 26 may be embedded in cameras 22. In the embodiment shown in FIG. 1, however, camera controller 26 receives control signals from image server 32 designating selected regions of a remote physical location. Camera controller 26, in response to such control signals, selects a camera, changes the position (pan and tilt, for example) and magnification (zoom) of the selected camera such that it captures the desired image of the selected region 62. In other embodiments, the image acquisition system comprises a single fixed camera returning a live still or video image of a remote physical location.

A variety of communication paths between camera controller 26 and image server 32 are possible. As FIG. 1 illustrates, camera controller 26 can be directly connected to server 32. Such a connection could also occur via a local area network (LAN) or a wireless communication system. Alternatively, as FIGS. 2 and 3 illustrate, communication between camera controller 26 and image server 32 can occur via the Internet 40 or other wide-area network. Additionally, image acquisition system 20 and image server 32 can be in the same physical space. Moreover, the functionality of image server 32 can be incorporated into camera controller 26.

In one embodiment, cameras 22 are computer-controlled cameras, whose pan, tilt (angular positions) and zoom settings are controlled and adjusted electro-mechanically by servo motors, as is conventional. In addition, cameras 22 could be movably mounted on tracks located at the remote physical location. Their position on the track could be similarly controlled by servo motors. Cameras 22 can be video cameras or still cameras. In addition, cameras 22 can be analog cameras, whose signal is digitized by a conventional frame-grabber. Cameras 22 can also be digital cameras, or any other suitable camera system. In one embodiment, cameras 22 are analog cameras that take still images. According to this embodiment, camera controller 26 includes a frame-grabber board or other suitable device for digitizing the camera signal. According to one embodiment, camera controller 26 converts the resulting image into a JPEG or GIF (or any other suitable format) image data file before it is transmitted to image server 32. In other embodiments, the camera signal is transmitted to image server 32, which converts the signal into a suitable format.

Additionally, currently available telepresence systems of widely varying configurations may be employed in the present invention. For example, embodiments of the present invention may employ cameras having a fixed angular position with wide-angle view systems (including parabolic or “fish eye” lenses) such that displacement of the camera in the pan and tilt directions is unnecessary to capture images of the entire remote physical location. U.S. Pat. No. 5,877,801 provides an example of such a telepresence system. According to the '801 patent, the camera system transmits a distorted image of the entire field of view to a local site that processes the image data to display that portion of the image selected by the user. In one form, image server transmits control signals to the fixed camera directing that a new image be taken of the entire region. In one embodiment employing such a camera system, image server 32, a device controller connected thereto, or a applet or plug-in on the network access device, processes the distorted image to derive the image of the selected region designated by a user with the user interface. Still further, the image acquisition system may include an array of cameras extending radially from a common point in combination with software to stitch the resulting images together, as offered by Infinite Pictures Corporation as part of its “SmoothMove” Technology. Other suitable camera systems include a fish eye lens and de-warping and spherical viewing image processing software, such as that disclosed in U.S. Pat. No. Re. 36,207. Other suitable systems may include a camera system using a convex mirror disclosed in U.S. Pat. No. 5,760,826.

C. Network Access Device

Users access telepresence control system 30 with a network access device 50, which receives, displays and transmits data over a computer network. In one embodiment, a network access device is a browser 52 executed on a personal computer, a browser 52 executed on a network computer, or a browser on a cell phone or personal digital assistant. However, any suitable device and/or application for accessing and displaying data transmitted over a computer network can be used.

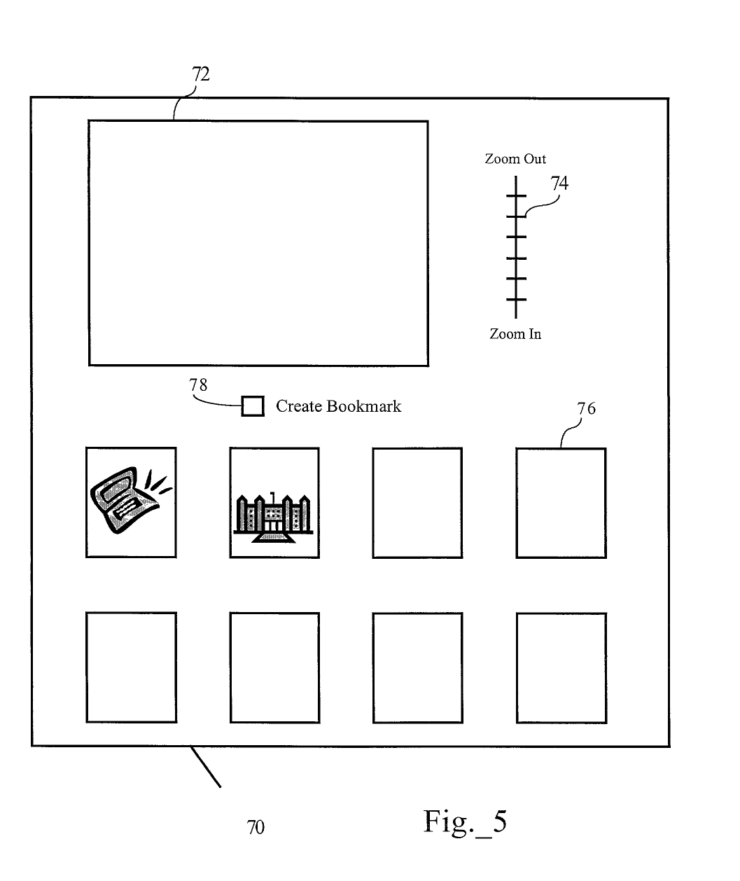

FIG. 5 illustrates one embodiment of a user interface 70 displayed by the network access device 50. The user interface allows users to navigate remote physical location 60 by receiving images of selected regions therein and allowing the user to designate a new selected region for viewing. A remote physical location, in one embodiment, is an actual physical space or location remote from the user. It is remote only in the sense that it is perceived through a user interface displayed on a computer screen or other suitable device. Accordingly, a remote physical location can include within its bounds a network access device. In one embodiment, users, employing the controls provided by the user interface, remotely control image acquisition system 20 via image server 32. As discussed more fully below, the user interface also provides an image history allowing users to see and navigate directly to previously viewed regions of remote physical location 60.

One embodiment of the user interface is implemented using page-based interfaces transmitted to a conventional computer 50 having an Internet browser 52 and a connection to the Internet 40. The user's computer 50 can be any computer, special-purpose computing device, or any other suitable device for performing the required functionality. In one embodiment, user computer 50 includes at least one processor, a data storage system (including volatile and non-volatile media), a keyboard, a display, at least one input device and at least one output device. In one embodiment, the user's computer is connected to the Internet via a modem dial-up connection or through a network line. Such communication, however, could also be wireless. In addition, although embodiments of the system are described as working in conjunction with a browser, any suitable device or application for receiving, displaying and transmitting data over a computer network can be used with the present invention.

The use of page-based interfaces is desirable since such interfaces work on most browsers. However, the interface may also be provided on the user's computer via a Java applet or a client-side plug-in which the user downloads prior to using the system. In these embodiments, servers 32 and 36 transmit interface data (such as image and image history data) which the applet or plug-in receives and displays on the user interface appearing on the user's computer. The interface may also be provided by a separate, special purpose application, which operates independently of a browser. Additionally, the present invention may work in conjunction with a special purpose kiosk or WebTV player.

### II. Operation

In one embodiment, a user at network access device 50 accesses telepresence control system 30 using browser 52 or any other suitable application. Web servers 36 receive requests from network access device 50, transmit the request to image server 32 for processing, and ultimately transmits data to the user in response to the request. According to one embodiment of the present invention, image server 32 transmits, in response to an image request, control signals to image acquisition system 20, receives image data in return, constructs page-based interfaces (see, e.g., FIG. 5) including the image data, and transmits them to network access devices 50 via web server 36 and computer network 40. As more fully discussed below, the page-based interfaces allow users to remotely control image acquisition system 20 in order to navigate the remote physical location in which the image acquisition system is located.

In one embodiment, when a user request comes to image server 32, image server 32 directs image acquisition system 20 to capture a new picture (image) of a selected region 62 in remote physical location 60 (see FIG. 7). In one embodiment, when the user request does not designate a selected region of the remote physical location (such as an initial request to telepresence control system 30), the first image taken and ultimately transmitted to the user is taken from a so-called default camera oriented at default pan, tilt and zoom values. This “default” image typically provides a user a view of the entirety of the viewable space. As discussed above, camera controller 26 moves the selected camera 22 to the default positional parameter values (pan, tilt, and zoom, in one embodiment) and causes camera 22 to take a live image or picture. In one embodiment, camera controller 26 includes a conventional frame grabber, which digitizes the image. Camera controller 26 further converts the digitized image into a JPEG image file (or any other suitable image file format) and transmits the image file to image server 32. In one embodiment, server 32 stores the file in image buffer database 33. In one form, the positional parameters of the camera (pan, tilt and zoom values) are encoded into the file name pointing to the stored image file. In embodiments where the image acquisition system 20 includes more than one camera system, the identity of the camera that captured the image is encoded into the file name. Other parameters, such as the time and/or date at which the image was taken, may be encoded in the file name as well. In addition, in other embodiments, image server 32 need not store the image file in image buffer database 33, but may transmit it directly to the user.

According to the invention, server 32 transmits the image to the user. In one embodiment, server 32 transmits interface data to the user including the image of the selected region of the remote physical location 60. In one embodiment, server 32 constructs a user interface (see, e.g., FIG. 5) which includes the requested image and transmits the interface to network access device 50. In one embodiment, the user interface is a page-based interface. More specifically, and according to one embodiment of the present invention, server 32 stores a page-based interface template containing certain tags, which are replaced with data, program code, and/or pointers to files, before the resulting page (interface data) is transmitted to the user. In one embodiment using HTML pages, to construct the page-based interface, server 32 replaces a tag reserved for the image with code that, when parsed by browser 52, creates an HTML form containing the requested image as a standard HTML image map. In one form, the HTML form code contains a file name pointing to the requested JPEG image file (or other suitable format) stored in image buffer database 33. Accordingly, the image map, after the page has been transmitted to browser 52, allows the user to click in the image 72 (see FIG. 5) of interface 70 to transmit a request for a live image of a new selected region 62 in remote physical location 60.

In one form, the x- and y-coordinates corresponding to the point in the HTML image map at which the click occurred are transmitted to server 32 as part of a URL, constructed by browser 52, that also contains the pan, tilt, zoom and other camera parameters corresponding to the old image, contained in the HTML document as hidden fields. In one embodiment, discussed more fully below, a View object representing the field of view and other image/camera parameters of an image is transmitted as a parameter in the URL. Furthermore, in one embodiment, the URL is constructed from an HTML <FORM> tag or from an applet. Using the positional parameters of the currently viewed image and the x-and y-coordinates of the user's click in the image map, server 32 determines which one of cameras 22 (if more than one exist) to move and the positional parameters (pan, tilt and zoom values, in one embodiment) of such move necessary to capture an image of the selected region. In one embodiment, the desired image is captured and a new page-based interface is generated and transmitted to the user as described above. Accordingly, the user interface described in this embodiment allows the user to visually navigate through remote physical location 60 simply by clicking in the displayed image and/or specifying the desired magnification.

In yet other embodiments, the interface can be configured to allow the user to select a region in the remote physical location by designating an area in the displayed image, rather than just clicking at a particular point in the image. In one embodiment, the user may designate such an area by clicking in the image and dragging to create a box as is commonly found in many software applications. The interface then returns the coordinates of the box, rather than the x, y-point of the click, as described above, in order to request the image of the selected region.

FIG. 5, as discussed above, shows an embodiment of a user interface according to the present invention. As FIG. 5 illustrates, interface 70 includes image window 72 and interface controls. In the embodiment shown, interface controls include camera zoom control 74, image history thumbnails 76, and bookmark box 78. As alluded to above in the description of one embodiment, a digital representation of the captured image is added as an image map to interface 70 at image window 72. As described above, interface 70 allows the user to navigate through remote physical location 60 by transmitting requests to server 32 which points cameras 22 to selected regions of remote physical location 60. As FIG. 5 indicates, certain embodiments provide the user the ability to control the zoom or magnification of cameras 22. More specifically, interface 70 includes zoom control 74 offering various zoom values. In the embodiment shown, the user simply adjusts the zoom value and selects a point in the image to which he or she wishes to zoom. In one form, the user interface also includes a panoramic view to enhance the user's ability to navigate within a physical space (not shown). As with image window 72, the user may click in the image of the panoramic view to aim image acquisition system 20 at a new selected region. The new image is added to the interface template at image window 72 and transmitted to the user as discussed above. In this manner, the user may quickly navigate to other regions of remote physical location 60, even though the currently viewed image is zoomed in on a small region in remote physical location 60. Moreover, as discussed more fully below, thumbnail images 76 include links operable to request the corresponding images.

A. Object-Oriented Embodiment

One embodiment of the present invention employs the principles of object-oriented programming and represents views, images, sessions, and users as objects. In one embodiment, the field of view corresponding to a particular image is represented as a View object, which is transmitted with the image data and embedded in the page-based interface transmitted to the user. In one embodiment, the attributes of a View object include the positional parameters for the image in relation to the position of the camera. In one embodiment, View object attributes include a pan and tilt range corresponding to the image, as well as the width and height of the image. In one embodiment, the positional parameters relate to the actual positional parameters of a movable camera. In one embodiment, such positional parameters include the pan, tilt and/or zoom values of a computer-controlled pan-tilt-zoom camera 22. In other embodiments employing stationary cameras (such as a camera incorporating a fish eye lens) and image processing algorithms, the positional parameters relate to the location of the selected region in the image captured by the stationary camera.

As discussed above, in one embodiment, a request for a new image comprises the image parameters of the old or source image, plus the x-and y-coordinates of the click point in the source image and/or zoom parameters. In one embodiment, the View object corresponding to the source image (the SourceView object, for purposes of description) is transmitted with the request. In response to the user request, image server 32 constructs a TargetView object from the SourceView object and the x-y coordinates of the click point (and/or zoom parameters) associated with the request. Image server 32 transmits the TargetView object to the appropriate image acquisition system 20. Image acquisition system 20 captures the requested image and returns corresponding image data to image server 32. Image server 32 then constructs an Image object, which inherits the attributes of the TargetView object and includes other attributes, such as a unique identifier corresponding to the image, a camera identifier corresponding to the camera that captured the image, the time at which the image was taken, the image data, and image processing parameters (e.g., brightness, quality, compression, image data format [e.g., JPEG, GIF, TIFF]). In one embodiment, image server 32 further constructs a DiskImage object. In one form, a DiskImage object inherits the attributes of an Image object and further includes an absolute file path or locator pointing to where the image data is stored in image buffer database 33. In one embodiment, the image data is stored as a JPEG, GIF or other suitably formatted file in a managed directory structure on a non-volatile medium, such as magnetic disk. In another embodiment, the image data is stored as Binary Large OBjects (BLOBs) in a SQL database. In one embodiment, the DiskImage object may also include thumbnail image data generated from the particular image. In one form, image server 32 accesses a DiskImage object to construct a page requested by the user. In one embodiment, DiskImage objects are further converted into Picture objects. In one embodiment, a Picture object inherits the attributes of a DiskImage object and further includes meta data, such as a caption, title, or SKU number, facilitating storage and retrieval of the Picture object in image history database 38. In one embodiment, DiskImages associated with a particular user's session are converted into Picture objects upon termination of the session.

B. Sessions, User Objects and Image Histories

One embodiment of the invention uses session-related information in order to consistently associate a client with the images that they have taken and thereby maintain image histories associated with a session and/or a particular user. One embodiment employs the Java session APIs that provide a mechanism to identify a user across multiple requests and, thus, to provide stateful information and/or services to the user. Of course, the particular APIs employed to maintain sessions depend on the server platform. In one embodiment involving the HTTP protocol, when a new user request is received, a new HttpSession object is created to represent the user's session. In one form, a corresponding cookie is created by browser 52 on network access device 50. In one embodiment, the cookie maintains a unique session identifier associated with the HttpSession object. In one embodiment, the HttpSession object includes a pointer to a User object. In one embodiment, the User object includes an image history including pointers to the DiskImage objects associated with a particular user. In one form, the User object can be associated with a unique user identifier and stored in a database to allow access to image histories in subsequent sessions.

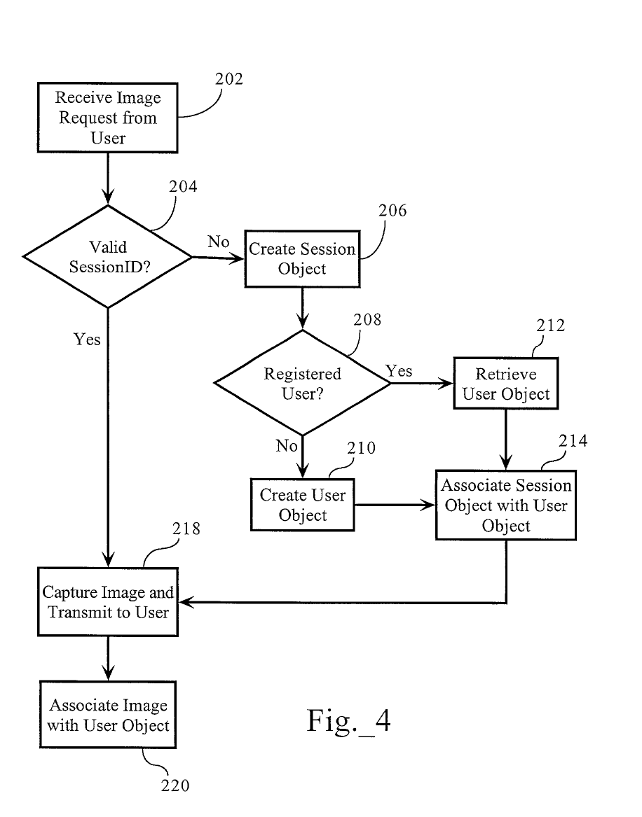

FIG. 4 illustrates a method employing Session objects corresponding to respective user sessions. In one embodiment, when web server 36 receives a request (FIG. 4, step 202), it determines whether the request includes a valid session identification (step 204). In one embodiment, sessions are maintained using cookies. In another embodiment, sessions are maintained using URL re-writing techniques. If there is no valid session identifier, server 36 creates a new HttpSession object including a unique session identifier (step 206). In one form using cookies, telepresence control system packages the session identifier in a cookie. In one embodiment, telepresence control system 30 allows access to both registered and unregistered users. In one form, telepresence control system 30 requires registered users to log in by providing a user identification and a password. If the user provides a valid user identification and password (step 208), the user is considered registered. Server 36, therefore, retrieves the User object associated with the user identifier from user database 34 (step 212). In one embodiment, server 36 creates a temporary User object for unregistered users (step 210). In either case, server 36 associates the User object with the HttpSession object (step 214). Telepresence control system 30 then captures the image requested by the user and transmits it as described above (step 218). Server 36 further associates the DiskImage object corresponding to the request with the User object (step 220). In one embodiment, each User object includes a list of pointers to associated DiskImage objects. In one form, the list of pointers is a HashMap, wherein the pointers are hashed values associated with their corresponding DiskImage and/or Picture objects. In one embodiment, as the user navigates through a remote physical location, server 36 merely adds more pointers to this list.

In one embodiment, when the user session ends (e.g., when the session times out or the user explicitly logs out), the image history represented by the list of pointers is stored in a database in association with the user's account for further use. In one form, the Picture objects corresponding to the images captured during the user's session are stored in image history database 38. In one embodiment, if the user is a registered user, the image history is stored in user database 34 and retrievable by the user in a subsequent session. In another embodiment, image histories are stored in a administrator's database for analysis of system use. In one embodiment, images requested by a registered user are added incrementally, rather than upon termination of a session, to the user's image history stored in user database 34 as the user navigates the remote physical location.

1. Use of Image Histories

Image histories can be used in a variety of ways. In one embodiment, image histories enhance the user's ability to navigate remote physical locations. In one embodiment, image histories enable telepresence control system 30 to include a representation of the image history corresponding to a particular session and/or user in the interface including the current image. For example, and in one embodiment, the interface transmitted to the user includes links to the images requested by the user during the current session. In one embodiment, the interface includes only the last N images requested by the user during the current session.

To enhance navigation of a remote location, the user may simply click on one of the links to view an image in the image history. In one embodiment, the link is operable to display the originally captured image (e.g., such as a DiskImage or Picture, see above). In one embodiment, the links provided by the image history are operable to request a new live image of the selected region in the remote physical location. In one form, the link encodes the View object corresponding to the image, which includes the parameters (e.g., camera identifiers and positional parameters) required to capture the new live image.

One embodiment of the present invention provides a visual representation of the user's session/image history. For example, as FIG. 5 illustrates, the links can be embedded in thumbnail images 76. In one embodiment, the thumbnail images include embedded links to the respective, captured DiskImages or Pictures. In another embodiment, the thumbnail images include embedded links operable to capture a new image from the image source.

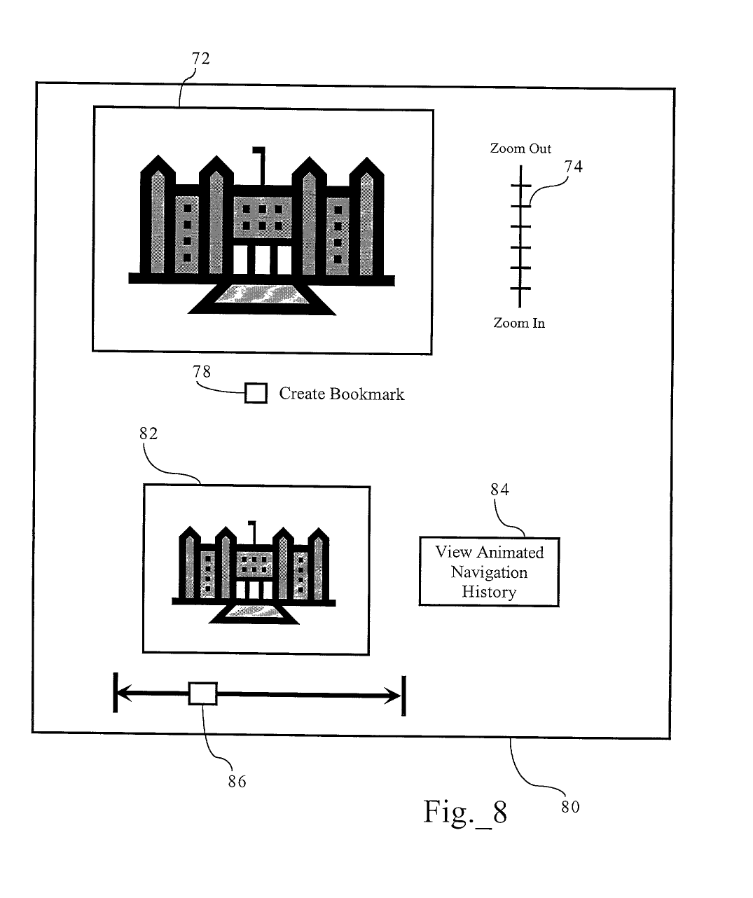

One embodiment provides an animated visual representation of the user's session/image history. FIG. 8 illustrates a user interface 80 including an image history window 82, animation view button 84, and slider control 86. In one form, image history window 82 displays, by default, the previously viewed image. If the user presses on animation view button 84, the user's session is replayed (i.e., the images associated with the user's image history are displayed in sequence with a delay between images to allow the user adequate time to perceive each one). In one form, user interface 80 further includes slider control 86 allowing the user to scroll through the image history, as opposed to viewing an animated sequence. In one embodiment, the images displayed in image history window 82 are thumbnail images. In another embodiment, image history window 82 is substantially the same size as image window 72. In one embodiment, each image includes an embedded link operable to transmit a request for a new live image of the remote physical location from image acquisition system 20. Therefore, in one embodiment, a user may scroll through the image history using slider control 86 and click on the currently displayed historical image to transmit a request for a corresponding live image.

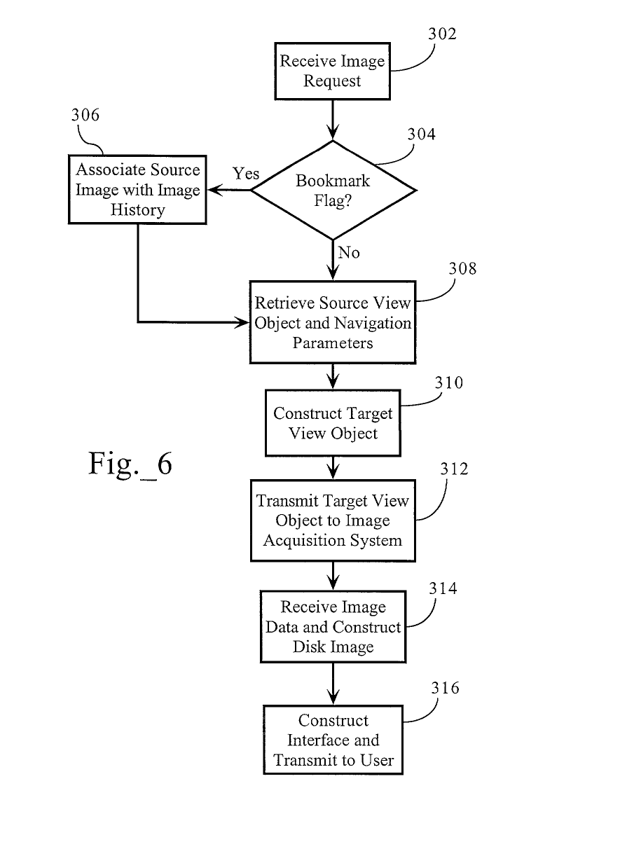

In one embodiment, image histories provide a method of “bookmarking” the user's session. In one form, the user interface allows users to bookmark the currently viewed image by checking a box 78, or activating a button (not shown), and clicking in the image to navigate to another region in the physical location. FIG. 6 illustrates a method facilitating bookmarking of images. In one embodiment, image server 32 receives an image request (step 302) and checks whether the request includes a bookmark flag (step 304). If so, image server 32 associates the source image with the user's image history. In one form, image server 32 adds a pointer to the corresponding DiskImage in the image history associated with the user or session identification (step 306). Image server 32, in one embodiment, retrieves the source View object and the navigation parameters (e.g., click points and/or zoom values) (step 308). Image server 32 constructs a TargetView object (step 310) and transmits it to the appropriate image acquisition system (step 312). Image server 32 receives image data and, in one embodiment, constructs a DiskImage object (step 314). Image server 32 then constructs an interface including the requested image and a representation of the bookmarks/image history associated with the session and/or user (step 316).

In one embodiment, image histories are persistent across sessions. For example, in one embodiment involving registered users, image histories are associated with user identifications in user database 34. In one form, users log in by providing a user identification and, optionally, a password to allow image server 32 to retrieve corresponding histories stored in user database 34. In one embodiment, image server 32, at initiation of a registered user's session, queries user account database 34 for the image history associated with the account and adds a representation of the image history to the interface data transmitted to the user.

One embodiment of the present invention includes an administrator interface allowing access to user accounts and image histories. In one embodiment, image histories allow an administrator to analyze and/or monitor usage of the system. For example, in one embodiment, image histories can be processed to yield the frequency at which regions in a physical location are viewed. In one form, the administrator can determine the most frequently viewed region in the physical location.

One embodiment of the present invention includes an active users console displaying in real time the most recent images corresponding to a plurality of users currently using the telepresence system. In one form, the administrator can access the image history of a user associated with one of the images displayed on the console by clicking on a particular image. In one form, the administrator can view an animated version of the user's session (see above). The administrator can view the image history including a visual representation thereof and take appropriate action, such as targeting, in a pop-up window or by some other method, an advertisement or an invitation to chat to the user. If a chat ensues, in one embodiment, the visual history is added to the chat discussion interface to facilitate discussion about the user's session. In one embodiment, the chat discussion interface further includes an image window and controls allowing for further navigation of the remote physical location.

2. Managing Image Histories

In one embodiment, telepresence control system 30 includes functionality ensuring that User objects and associated image histories are managed effectively. In one embodiment, such functionality is operable to remove image histories associated with users who have become inactive. Various metrics can be employed in determining whether a User has become inactive, the time of the last request being the simplest. Alternatively, the density of a particular User's request in time can also be used. In one embodiment, telepresence control system 30 also manages the quantity of DiskImages contained in each User's ImageHistory. In one embodiment, the management functionality of telepresence control system 30 deletes DiskImages from a User's ImageHistory when a certain size is reached. Alternatively, telepresence control system 30 can limit the size of the each User's ImageHistory by summing the sizes of each User's ImageHistory, and purging the oldest DiskImages from each User's ImageHistory. Another metric that can be used to manage the size of a User's ImageHistory is to purge all DiskImages that have aged past an arbitrary date.

What is claimed is:

1. A system allowing for navigation of a remote physical location over a computer network comprising
a network access device operably coupled to the computer network;
an image server operably coupled to the computer network to receive image requests from the network access device and transmit images in response;
an image acquisition system operably coupled to the image server;
wherein the image acquisition system captures an image of the remote physical location in response to control signals transmitted by the image server;
wherein the network access device comprises a user interface allowing a user to navigate the remote physical location by requesting and displaying images of selected regions in the remote physical location;
wherein the image server maintains an image history associated with the user.

2. The system of claim 1 wherein the image server transmits a representation of the image history to the network access device.

3. The system of claim 2 wherein the user interface displays the representation of the image history.

4. The system of claim 1, 2, or 3 wherein the image history comprises the user's session.

5. The system of claim 2 wherein the image server generates a visual representation of the image history and is operable to display the visual representation on the user interface.

6. The system of claim 5 wherein the visual representation comprises a series of thumbnail images corresponding to the history of images.

7. The system of claim 4 wherein the image server generates a visual representation of the user's session and displays the visual representation on the user interface.

8. The system of claim 7 wherein the visual representation comprises a series of thumbnail images corresponding to the user's session.

9. The system of claim 1 wherein the image server stores image histories in a database upon termination of a user's session.

10. The system of claim 9 wherein the image server stores the image histories in association with a session identifier.

11. The system of claim 9 wherein the image server stores the image histories in association with a user identifier.

12. The system of claim 1 wherein the image server incrementally stores the image history in a database as the user navigates the image acquisition system during the user's session.

13. The system of claim 12 wherein the image server stores the image histories in association with a session identifier.

14. The system of claim 12 wherein the image server stores the image histories in association with a user identifier.

15. The system of claim 6 wherein the thumbnail images contain embedded links to the corresponding image.

16. The system of claim 8 wherein the thumbnail images contain embedded links to the corresponding image.

17. The system of claim 6 wherein the thumbnail images contain embedded links operable to cause the image acquisition system to capture a new image of the remote physical location.

18. The system of claim 8 wherein the thumbnail images contain embedded links operable to cause the image acquisition system to capture a new image of the remote physical location.

19. The system of claim 1 wherein the image history comprises a plurality of images bookmarked by the user.

20. The system of claim 1 9 wherein the image server generates a visual representation of the bookmarked images and is operable to display the visual representation on the user interface.

21. The system of claim 20 wherein the visual representation comprises a series of thumbnail images.

22. The system of claim 21 wherein the thumbnail images contain embedded links operable to cause the image acquisition system to capture a new image of the remote physical location.

23. The system of claim 5 wherein the visual representation is an animated visual representation comprising a series of images associated with the image history.

24. The system of claim 23 wherein the user interface allows for control of display of the animated representation.

25. The system of claim 23 or 24 wherein the images contain embedded links operable to cause the image acquisition system to capture a new image of the remote physical location.

26. The system of claim 1 further comprising an administrator interface operably coupled to the image server; wherein the administrators interface allows access to image histories maintained by the image server.

27. The system of claim 1 wherein the administrator interface includes an active users console; wherein the active users console displays the most recent requested images corresponding to a plurality of currently active users.

28. The system of claim 27 wherein the active users console facilitates access to the image histories associated with the plurality of currently active users.

29. The system of claim 28 wherein the active users console facilitates targeting of a communication to at least one of the plurality of currently active users.

30. An apparatus facilitating navigation of a remote physical location via an image acquisition system located therein, comprising
an image database including a plurality of image objects representing images captured by the image acquisition system,
an image server operably connected to the image acquisition system,
the image server being operable to direct the image acquisition system to capture images of selected regions of the remote physical location in response to image requests transmitted by individual users;
wherein the image server stores data representing the captured images in the image database in respective image objects;
wherein the image server maintains session objects representing respective user sessions;
the image server further being operable to associate image objects with corresponding user sessions.

31. The apparatus of claim 30 wherein the image server associates user objects with corresponding session objects; the user objects representing individual users; and wherein the image server is operable to associate image objects with respective user objects.

32. The apparatus of claim 30 wherein each user object includes an attribute representing an image history associated with the user.

33. The apparatus of claim 30 wherein the image history comprises image objects associated with the user object.

34. The apparatus of claim 30 wherein the image history comprises pointers to image objects associated with the user object.

35. The apparatus of claim 30 wherein the image history comprises a list of pointers to image objects associated with the user object.

36. The apparatus of claim 30 further comprising a user database including a plurality of user objects, and an image history database including a plurality of archived image objects.

37. The apparatus of claim 36 wherein the image server stores the image objects associated with a terminated session in the image history database.

38. The system of claim 30 wherein the image server incrementally stores the image history in a database as the user navigates the image acquisition system during the user's session.

39. The system of claim 38 wherein the image server stores the image histories in association with a session identifier.

40. The system of claim 38 wherein the image server stores the image histories in association with a user identifier.

41. The apparatus of claim 32 or 33 wherein the image server transmits a representation of the image history with the image requested by the user.

42. The apparatus of claim 41 wherein the image history comprises the user's session.

43. The apparatus of claim 42 wherein the image server generates a visual representation of the user's session.

44. The apparatus of claim 43 wherein the visual representation comprises a series of thumbnail images corresponding to the history of images maintained by the image server.

45. The apparatus of claim 44 wherein the thumbnail images contain embedded links to the corresponding image.

46. The apparatus of claim 44 wherein the thumbnail images contain embedded links operable to cause the image acquisition system to capture a new image of the remote physical location.

47. The apparatus of claim 30 wherein the image server associates flagged image objects with corresponding user sessions.

48. The apparatus of claim 30 wherein the flagged image objects are bookmarked by users.

49. An apparatus facilitating navigation of a remote physical location over a computer network, the remote physical location including an image acquisition system capturing images of selected regions therein, comprising
a network access module allowing for access to resources on the computer network;
a user interface associated with the network access module, the user interface being operable to facilitate navigation of a remote physical location by requesting images of selected regions in the remote physical location over the computer network;
wherein the user interface displays requested images and an image history.

50. The apparatus of claim 49 wherein the user interface displays a visual representation of the image history.

51. The apparatus of claim 50 wherein the visual representation comprises a series of thumbnail images.

52. The apparatus of claim 51 wherein the thumbnail images contain embedded links to corresponding images.

53. The apparatus of claim 52 wherein the thumbnail images contain embedded links operable to request corresponding live images.

54. The apparatus of claim 49 or 50 wherein the user interface facilitates the bookmarking of images; and wherein the image history comprises a plurality of bookmarked images.

55. The system of claim 50 wherein the visual representation is an animated visual representation comprising a series of images associated with the image history.

56. The system of claim 55 wherein the user interface allows for control of display of the animated representation.

57. The system of claim 55 or 56 wherein the images contain embedded links operable to cause the image acquisition system to capture a new image of the remote physical location.

58. A method allowing for navigation of a remote physical location over a computer network, the method comprising the steps of:
(a) receiving an image request, the request including a session identifier;
(b) computing an image parameter set;
(c) transmitting control signals to an image acquisition system, the control signals be operable to direct the image acquisition system to capture an image defined by the image parameter set;
(d) maintaining an image history associated with the session identifier;
(e) transmitting the image and the image history associated with the session identifier in response to the image request.

59. The method of claim 58 further comprising the step of
(f) repeating steps (a)-(e) a desired number of times.

60. The method of claim 58 or 59 wherein the maintaining step (a) comprises the step of
(d1) storing the image parameter set in association with the session identifier.

61. The method of claim 60 wherein the image history transmitted in step (e) comprises the image parameter set(s) associated with the session identifier.

62. The method of claim 61 wherein the image parameter set(s) transmitted in step (e) are links to the corresponding image.

63. The method of claim 62 wherein the image parameter set(s) transmitted in step (e) are links to a live image, wherein the link(s) is(are) operable to request a new image defined by the image parameter set(s).

64. The method of claim 58 or 59 wherein the transmitting step (e) comprises the steps of
(e1) transmitting the image and a visual representation of the image history associated with the session identifier.

65. The method of claim 64 wherein the visual representation comprises a series of thumbnail images corresponding to the image history.

66. The method of claim 65 wherein each thumbnail image includes an embedded link to the corresponding image.

67. The method of claim 65 wherein each thumbnail image includes an embedded link, wherein the embedded link is operable to request a live image corresponding to the thumbnail image.

68. A method allowing for navigation of a remote physical location via a telepresence system operably connected to a computer network, the method comprising the steps of:
(a) receiving an image request, the request including a session identifier;
(b) computing an image parameter set;
(c) transmitting control signals to an image acquisition system, the control signals be operable to direct the image acquisition system to capture an image defined by the image parameter set;
(d) maintaining an image history associated with the session identifier.

69. The method of claim 68 further comprising the step of
(e) repeating steps (a)-(d) a desired number of times for a plurality of sessions.

70. The method of claim 69 further comprising the step of
(f) analyzing the image histories to quantify factors relating to usage of the telepresence system.
